(19) United States
(12) Patent Application Publication
(10) Pub. No.: US 2011/0239302 A1
(43) Pub. Date: Sep. 29, 2011

(54) APPARATUS AND METHOD FOR PERFORMING SYSTEM EVALUATION IN PORTABLE TERMINAL

(75) Inventor: Won-Ha CHOI, Seoul (KR)

(73) Assignee: SAMSUNG ELECTRONICS CO. LTD., Suwon-si (KR)

(21) Appl. No.: 13/051,416

(22) Filed: Mar. 18, 2011

(30) Foreign Application Priority Data
Mar. 29, 2010 (KR) 10-2010-0027728

(51) Int. Cl. G06F 12/14

(52) U.S. Cl. 726/24; 726/22

(57) ABSTRACT

An apparatus and method for performing a system evaluation such as real-time virus scan/diagnosis/cure in order to improve system performance in a portable terminal are provided. The apparatus includes an operation monitoring unit for determining an idle state duration and an active state duration by monitoring an operation of the portable terminal, and a pattern analysis unit for defining the idle state duration as a system evaluation duration.

### PRIORITY

This application claims the benefit under 35 U.S.C. §119(a) of a Korean patent application filed in the Korean Intellectual Property Office on Mar. 29, 2010 and assigned Serial No. 10-2010-0027728, the entire disclosure of which is hereby incorporated by reference.

### BACKGROUND OF THE INVENTION

1. Field of the Invention

The present invention relates to an apparatus and method for performing a system evaluation such as a real-time virus scan/diagnosis/cure in a portable terminal. More particularly, the present invention relates to an apparatus and method for performing a system evaluation using a small number of processes in order to improve system performance in the portable terminal.

2. Description of the Related Art

Portable terminals have recently been widely used due to convenience of portability. As a result, in recent developments in the portable terminals, service providers (or terminal manufacturers) have competitively developed the portable terminals with more convenient functions to attract more users.

For example, a portable terminal provides various functions such as a phonebook, a game, a scheduler, a Short Message Service (SMS), a Multimedia Message Service (MMS), a Broadcast Message Service (BMS), an Internet service, an Electronic mail (E-mail), a morning call, a Motion Picture Expert Group (MPEG)-1 or MPEG-2 Audio Layer-3 (MP3) player, a digital camera, and other similar products and services.

The portable terminal has been developed into a smart phone by employing many functions of a computer. As a wireless network of the portable terminal is extended to a similar level of wireless Internet, the network can be damaged by the same virus that occurs in the computer.

For a detailed example of mobile virus damage, an incident occurred in the I-Mode of Japan (i.e., a representative mobile phone Internet service provider) in which hundreds of mobile phones made a call to an emergency number of the police in Japan due to a malignant code stored in software.

In addition, as the portable terminal can be used for stock and banking transactions, it is expected that mobile virus damage will gradually increase. It is also expected that the mobile virus damage is much more influential than computer virus damage due to an explosively increasing number of users of the portable terminals.

Recently, an increasing interest in the mobile virus has resulted in more anti-virus programs or system evaluation programs for portable terminals. The programs are installed in the portable terminals to reduce mobile virus damage by using real-time monitoring or scheduled evaluations.

However, functions such as the real-time monitoring require many system resources. Therefore, when the real-time monitoring is performed in the portable terminal that requires a large amount of processes, a problem exists in that system performance of the portable terminal deteriorates.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for improving system performance in a portable terminal.

Another aspect of the present invention is to provide an apparatus and method for improving system performance when a real-time monitoring function is performed in a portable terminal.

Still another aspect of the present invention is to provide an apparatus and method for performing a function for handling a mobile virus in an idle mode in a portable terminal.

A further aspect of the present invention is to provide an apparatus and method for determining an idle state duration by monitoring an operation of a portable terminal and for defining the idle state duration as a system evaluation duration.

In accordance with an aspect of the present invention, an apparatus for performing system evaluation in a portable terminal is provided. The apparatus includes an operation monitoring unit for determining an idle state duration and an active state duration by monitoring an operation of the portable terminal, and a pattern analysis unit for defining the idle state duration as a system evaluation duration.

In accordance with another aspect of the present invention, a method for performing system evaluation in a portable terminal is provided. The method includes determining an idle state duration and an active state duration by monitoring an operation of the portable terminal, and defining the idle state duration as a system evaluation duration.

In accordance with still another aspect of the present invention, an apparatus for performing a system evaluation in a portable terminal is provided. The apparatus includes a controller for allowing an operation pattern of the portable terminal to be analyzed by monitoring an operation of the portable terminal and for allowing the system evaluation to be performed in an idle state that requires a small number of processes, a system determiner for defining an idle state duration and an active state duration by analyzing the operation pattern of the portable terminal under the control of the controller and for performing the system evaluation in the idle state duration, and a memory unit for storing information on the idle state duration and active state duration defined by the system determiner.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating a structure of a portable terminal for performing a system evaluation according to an exemplary embodiment of the present invention;

FIG. 2 is a flowchart illustrating a process of performing a system evaluation in a portable terminal according to an exemplary embodiment of the present invention;

FIG. 3 is a flowchart illustrating a pattern analysis process of a portable terminal according to an exemplary embodiment of the present invention; and

FIG. 4 is a flowchart illustrating a system evaluation process of a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention described hereinafter relate to an apparatus and method for performing a system evaluation in a situation that requires a small number of processes in order to improve system performance in a portable terminal.

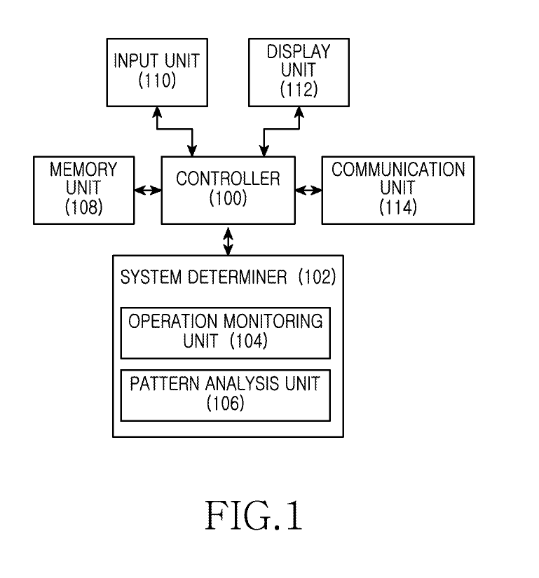

FIGS. 1 through 4, described below, and the various exemplary embodiments of the present invention provided are by way of illustration only and should not be construed in any way that would limit the scope of the present invention. Those skilled in the art will understand that the principles of the present disclosure may be implemented in any suitably arranged communications system. The terms used to describe various exemplary embodiments of the present invention are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a block diagram illustrating a structure of a portable terminal for performing a system evaluation according to an exemplary embodiment of the present invention.

Referring to FIG. 1, the portable terminal includes a controller 100, a system determiner 102, a memory unit 108, an input unit 110, a display unit 112, and a communication unit 114. The system determiner 102 includes an operation monitoring unit 104 and a pattern analysis unit 106. The portable terminal may include additional units that are not illustrated here merely for sake of clarity. Similarly, the functionality of two or more of the above units may be integrated into a single component.

The controller 100 of the portable terminal provides overall control to the portable terminal. For example, the controller 100 processes and controls voice calls and data communications, and in addition to its typical function, the controller 100 monitors an operation of the portable terminal to analyze an operation pattern of the portable terminal.

The controller 100 monitors the operation of the portable terminal to determine an idle state duration so that the system evaluation is performed in a situation that requires a small number of processes.

For example, the controller 100 can define the idle state duration and an active state duration by using a power-down time and a power-up time of the portable terminal.

After defining the idle state duration, the controller 100 defines the idle state duration as a system evaluation duration, so that the system evaluation is performed in a state that requires a small number of processes. In doing so, system performance of the portable terminal can be improved.

The system determiner 102 analyzes an operation pattern of the portable terminal under the control of the controller 100 and thus defines the idle state duration and the active state duration.

Thereafter, the system determiner unit 102 performs the system evaluation in the idle state duration.

The operation monitoring unit 104 of the system determiner unit 102 obtains information required to define the idle state duration and the active state duration of the portable terminal under the control of the system checking unit 102. That is, the operation monitoring unit 104 monitors the operation of the portable terminal to obtain information required to analyze the operation pattern. The operation monitoring unit 104 determines the power-down time and the power-up time of the portable terminal according to an exemplary embodiment of the present invention. Accordingly, the system checking unit 102 can determine the idle state duration of the portable terminal by using a duration between the power-down time and the power-up time (i.e., a duration after power down and before power up).

The pattern analysis unit 106 of the system checking unit 102 defines the idle state duration and the active state duration of the portable terminal under the control of the system checking unit 102.

In this case, the pattern analysis unit 106 defines the idle state duration and the active state duration of the portable terminal by using information obtained by the operation monitoring unit 104. The pattern analysis unit 106 can define the duration between the power-down time and the power-up time (i.e., the duration after power down and before power up) as the idle state duration of the portable terminal by determining the portable terminals' power-down time and power-up time obtained by the operation monitoring unit 104 according to an exemplary embodiment of the present invention.

The memory unit 108 includes a Read Only Memory (ROM), a Random Access Memory (RAM), a flash ROM or other similar storage devices. The ROM stores a microcode of a program, by which the controller 100 and the system determiner 102 are processed and controlled, and a variety of reference data.

The RAM is a working memory of the controller 100 and stores temporary data that is generated while programs are performed. The flash ROM stores a variety of rewritable data, such as phonebook entries, outgoing messages, incoming messages, information on a user's touch input point, and other similar data. The memory unit 108 stores information on the idle state duration and the active state duration defined by the pattern analysis unit 106.

The input unit 110 includes a plurality of function keys such as numeral key buttons of ‘0’ to ‘9’, a menu button, a cancel button, an OK button, a talk button, an end button, an Internet access button, a navigation key button, a character input key and other similar input keys and buttons. Key input data, which is input when the user presses these keys, is provided to the controller 100.

The display unit 112 displays information such as state information, which is generated while the portable terminal operates, moving and still pictures, and other similar displayable data and information. The display unit 112 may be a color Liquid Crystal Display (LCD), an Active Mode Organic Light Emitting Diode (AMOLED) display, and other similar display apparatuses. When the display unit 112 is equipped with a touch input device and thus is applied to a touch input-type portable terminal, the display unit 112 may be used as an input device.

The communication unit 114 transmits and receives a Radio Frequency (RF) signal of data that is input and output through an antenna (not illustrated). For example, in a transmitting process, data to be transmitted is subject to a channel-coding process and a spreading process, and then the data is transformed to an RF signal. In a receiving process, the RF signal is received and transformed to a base-band signal, and the base-band signal is subject to a de-spreading process and a channel-decoding process, thereby restoring the data.

Although a function of the system determiner 102 may be performed by the controller 100 of the portable terminal, the system determiner 102 and the controller 100 are separately constructed for exemplary purposes only. Thus, those of ordinary skill in the art can understand that various modifications can be made within the scope of the present invention. For example, functions of the system determiner 102 and the controller 100 may be integrally configured to be processed by the controller 100.

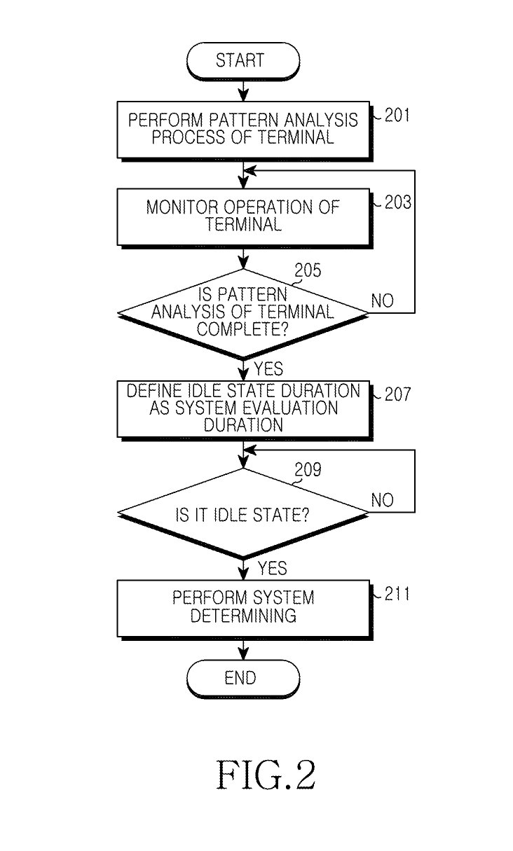

FIG. 2 is a flowchart illustrating a process of performing system evaluation in a portable terminal according to an exemplary embodiment of the present invention.

Referring to FIG. 2, the portable terminal performs an operation pattern analysis process of the terminal in step 201. Herein, the operation pattern analysis process is a process for determining an active state duration and an idle state duration of the portable terminal. The above process is used to perform the system evaluation in the idle state duration in order to address a system overload problem when the portable terminal performs real-time system evaluation in an environment having low memory capacity and low process capability.

In step 203, the portable terminal detects an operation of the terminal, it is determined in step 205 whether a pattern of the terminal is analyzed by using the detected operation of the terminal. In this process, the portable terminal detects the operation of the portable terminal to determine whether it is the idle state duration or the active state duration.

If it is determined in step 205 that the pattern analysis of the terminal is not complete, the portable terminal detects the operation of the portable terminal to analyze the pattern in step 203.

Otherwise, if it is determined in step 205 that the pattern analysis of the terminal is complete, the portable terminal defines the idle state duration determined by the pattern analysis process as a system evaluation duration in step 207.

In step 209, it is determined whether an operation state of the portable terminal is an idle state.

If it is determined in step 209 that the operation state of the portable terminal is not the idle state, step 209 is repeated.

Otherwise, if it is determined in step 209 that the operation state of the portable terminal is the idle state, the portable terminal performs system evaluation in step 211.

Since the portable terminal performs the system evaluation in a situation that requires a small number of processes as described above, system performance of the portable terminal can be improved.

Thereafter, the procedure ends.

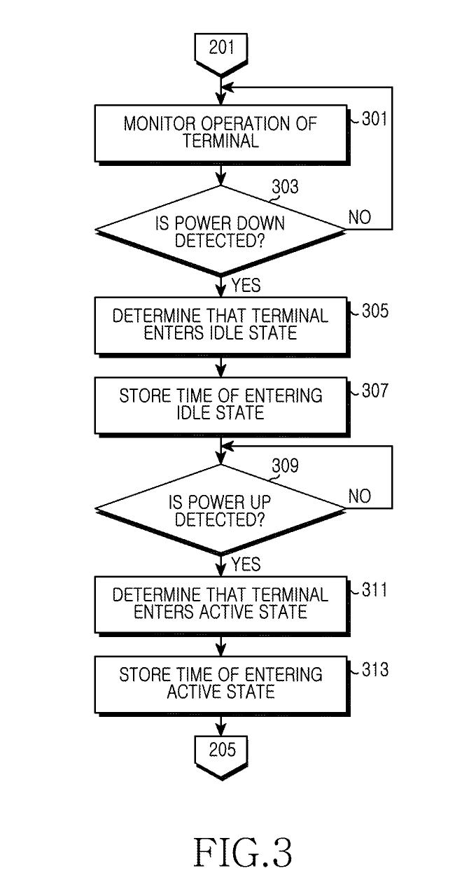

FIG. 3 is a flowchart illustrating a pattern analysis process of a portable terminal according to an exemplary embodiment of the present invention.

Referring to FIG. 3, the portable terminal monitors an operation of the terminal in step 301, and determines whether power-down of the portable terminal is detected in step 303. Herein, if the power-down situation is detected, the portable terminal can determine that this is a situation that requires a small number of processes. In addition, if it is determined that the power-down situation occurs during a call, since the situation occurs to decrease battery consumption of the portable terminal, the portable terminal does not determine that this is a situation that requires the small number of processes.

If the power down of the portable terminal is not detected in step 303, step 301 is repeated.

Otherwise, if the power down of the portable terminal is detected in step 303, it is determined in step 305 that the portable terminal enters an idle state. Then, in step 307, the portable terminal is allowed to store a time at which the portable terminal enters the idle state.

In step 309, it is determined whether power up of the portable terminal is detected. This process is used to determine a time at which the portable terminal switches to the power-up state from the power-down state.

If it is determined in step 309 that the power up of the portable terminal is not detected, it is determined that the portable terminal remains in the idle state, and step 309 is repeated.

In contrast, if it is determined in step 309 that the power up of the portable terminal is detected, it is determined that the portable terminal enters an active state in step 311. In step 313, a time at which the portable terminal enters the active state is stored.

Accordingly, the portable terminal can determine the idle state duration, and if the duration is maintained persistently, it can be determined that the portable terminal will enter the idle state periodically in the duration.

After storing the time of entering the idle state and the time of entering the active state, the portable terminal determines whether the pattern of the portable terminal is analyzed by using the stored time in step 205 of FIG. 2.

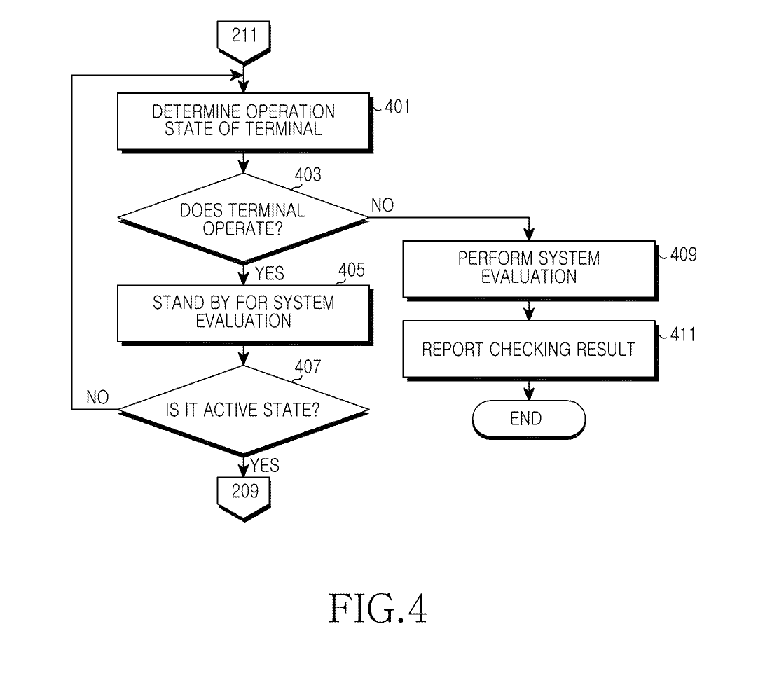

FIG. 4 is a flowchart illustrating a system evaluation process of a portable terminal according to an exemplary embodiment of the present invention.

Referring to FIG. 4, if the portable terminal intends to perform a system evaluation in step 211 of FIG. 2, the portable terminal determines an operation state of the portable terminal in step 401, and determines whether the portable terminal operates in step 403. In this process, the portable terminal determines whether the portable terminal that enters an idle state in step 401 switches to an active state at a time of performing the system evaluation.

If it is determined in step 403 that the portable terminal operates, the portable terminal stands by instead of performing the system evaluation in step 405.

This is to perform the system evaluation when the portable terminal enters an idle state that requires a small number of processes.

In step 407, it is determined whether the portable terminal enters an active state from the idle state.

If it is determined in step 407 that the portable terminal does not enter the active state from the idle state, step 401 is repeated.

In contrast, if it is determined in step 407 that the portable terminal enters the active state from the idle state, the process for determining whether to perform the system evaluation is performed in step 209 of FIG. 2.

Meanwhile, if it is determined in step 403 that the portable terminal does not perform an additional operation in a duration defined as the idle state, the portable terminal performs the system evaluation in step 409. Then, in step 411, the portable terminal reports a system evaluation result (i.e., an error report, and the like.).

Thereafter, the procedure ends.

As described above, exemplary embodiments of the present invention provide an apparatus and method for performing a system evaluation such as real-time virus scan/diagnosis/cure in a portable terminal. Since the system evaluation is performed in a situation that requires a small number of processes, a problem in which system performance of the portable terminal deteriorates can be addressed when a real-time evaluation is performed in the portable terminal that handles the processes in a conventional way.

While the present invention has been shown and described with reference to exemplary embodiments thereof, it will be understood by those skilled in the art that various changes in form and details may be made therein without departing from the spirit and scope of the present invention as defined by the appended claims and their equivalents.

What is claimed is:

1. An apparatus for performing a system evaluation in a portable terminal, the apparatus comprising:
an operation monitoring unit for determining an idle state duration and an active state duration by monitoring an operation of the portable terminal; and
a pattern analysis unit for defining the idle state duration as a system evaluation duration.

2. The apparatus of claim 1, further comprising a system determiner for determining whether the portable terminal currently operates in the idle state duration defined by the pattern analysis unit and for performing the system evaluation in the idle state duration.

3. The apparatus of claim 1, wherein the operation monitoring unit determines the idle state duration and the active state duration by using a power change of the portable terminal.

4. The apparatus of claim 3, wherein the operation monitoring unit monitors the operation of the portable terminal to detect the power change, determines that the portable terminal enters the idle state duration upon detecting power down of the portable terminal, and determines that the portable terminal enters the active state duration upon detecting power up of the portable terminal.

5. The apparatus of claim 4, wherein the operation monitoring unit stores a time of entering the idle state duration and a time of entering the active state duration and thereafter determines the idle state duration by using stored time information.

6. The apparatus of claim 2, wherein the system determiner determines whether the portable terminal operates before performing the system evaluation, and if it is determined that the portable terminal operates in the idle state duration, stands by for the system evaluation, otherwise if it is determined that the portable terminal does not operate in the idle state duration, performs the system evaluation.

7. The apparatus of claim 1, wherein the system evaluation comprises at least one of a virus scan, a diagnosis and a cure.

8. A method for performing a system evaluation in a portable terminal, the method comprising:
determining an idle state duration and an active state duration by monitoring an operation of the portable terminal; and
defining the idle state duration as a system evaluation duration.

9. The method of claim 8, further comprising:
after defining the idle state duration as the system evaluation duration, determining whether the portable terminal currently operates in the idle state duration; and
performing the system evaluation in the idle state duration.

10. The method of claim 8, wherein the determining of the idle state duration and the active state duration by monitoring the operation of the portable terminal comprises using a power change of the portable terminal.

11. The method of claim 10, wherein the determining of the idle state duration and the active state duration by monitoring the operation of the portable terminal comprises:
monitoring the operation of the portable terminal to detect the power change;
determining that the portable terminal enters the idle state duration upon detecting power down of the portable terminal; and
determining that the portable terminal enters the active state duration upon detecting power up of the portable terminal.

12. The method of claim 11, wherein the determining of the idle state duration and the active state duration by monitoring the operation of the portable terminal comprises:
storing a time of entering the idle state duration and a time of entering the active state duration; and
determining the idle state duration by using stored time information.

13. The method of claim 9, wherein the performing of the system evaluation in the idle state duration comprises:
determining whether the portable terminal operates before performing the system evaluation;
if it is determined that the portable terminal operates in the idle state duration, standing by for the system evaluation; and
if it is determined that the portable terminal does not operate in the idle state duration, performing the system evaluation.

14. The method of claim of claim 8, wherein the system evaluation comprises at least one of a virus scan, a diagnosis and a cure.

15. An apparatus for performing a system evaluation in a portable terminal, the apparatus comprising:
a controller for allowing an operation pattern of the portable terminal to be analyzed by monitoring an operation of the portable terminal and for allowing the system evaluation to be performed in an idle state that requires a small number of processes;
a system determiner for defining an idle state duration and an active state duration by analyzing the operation pattern of the portable terminal under the control of the controller and for performing the system evaluation in the idle state duration; and
a memory unit for storing information on the idle state duration and active state duration defined by the system determiner.

16. The apparatus of claim 15, wherein the system determiner defines the idle state duration and the active state duration by using a power change of the portable terminal.

17. The apparatus of claim 16, wherein the system determiner determines that the portable terminal enters the idle state duration upon detecting power down of the portable terminal, and determines that the portable terminal enters the active state duration upon detecting power up of the portable terminal.

18. The apparatus of claim 17, wherein the system determiner stores a time of entering the idle state duration and a time of entering the active state duration, and thereafter determines the idle state duration by using stored time information.

19. The apparatus of claim 18, wherein the system determiner stands by for the system evaluation if it is determined that the portable terminal operates in the idle state duration, and performs the system evaluation if it is determined that the portable terminal does not operate in the idle state duration.

20. The apparatus of claim 15, wherein the system evaluation comprises at least one of a virus scan, a diagnosis and a cure.
